(19) United States
(12) Patent Application Publication
(10) Pub. No.: US 2006/0185542 A1
(43) Pub. Date: Aug. 24, 2006

(54) Lithographic printing plate original form and plate making method

(76) Inventor: Koji Hayashi, Gunma (JP)

Correspondence Address: PATENT LEGAL STAFF, EASTMAN KODAK COMPANY, 343 STATE STREET, ROCHESTER, NY, 14650-2201, US

(21) Appl. No.: 10/544,191

(22) PCT Filed: Feb. 3, 2004
(86) PCT No.: PCT/JP04/01033

§ 371 Date: Mar. 29, 2006

(30) Foreign Application Priority Data
Feb. 4, 2003 (JP) 2003-027067

(51) Int. Cl. B41N 1/00

(52) U.S. Cl. 101/453

(57) ABSTRACT

The lithographic printing plate precursor of the present invention comprises a substrate 11 and a lipophilic layer 12 deposited on the substrate 11 wherein the lipophilic later 12 comprises a cross-linked product obtained by cross-linking a polymer having a thermally decomposable group on the main chain with a cross-linker. The lithographic printing plate precursor can be directly prepared by irradiating it with an infrared laser beam based on digital signals and mounted on a printer for printing in its existent state after exposure without developing, the lithographic printing plate precursor having an excellent ablation rate (sensitivity) and the obtained lithographic printing plate having an excellent plate life. The preparation method for a printing plate of the present invention is characterized by the fact that the lithographic printing plate precursor of the present invention is exposed to an infrared laser beam to remove the lipophilic layer in the exposed area.

### TECHNICAL FIELD

The present invention relates to a lithographic printing plate precursor and a preparation method for a printing plate. It particularly relates to a lithographic printing plate precursor that can be directly prepared by irradiating it with an infrared laser beam based on digital signals and mounted on a printer for printing in its existent state after exposure to light without developing and a preparation method for a printing plate.

### BACKGROUND ART

With recent improvements in computer image processing technologies, a technique to directly write an image in a photo-sensitive layer by irradiating it based on digital signals has been developed. A computer-to-plate (CTP) system is a focus of attention in which the above technique is applied to lithographic printing plates and images are directly formed in lithographic printing plate precursors without using silver salt mask films. A CTP system, which uses a high power laser having peak intensity in the near-infrared or infrared region as an irradiation light source, advantageously allows for high resolution images with short-time exposure and easy handling of lithographic printing plate precursors in a bright room. Particularly, a high power and small-sized solid-state or semiconductor laser emitting an infrared ray having a wavelength between 760 and 1200 nm is now available.

Japanese Unexamined Patent Application, First Publication No. H11-202481 discloses a positive lithographic printing plate precursor exposed to the aforementioned solid-state or semiconductor infrared laser and developed with a developer to form an image, the positive lithographic printing plate precursor having a photo-sensitive layer comprising a positive photo-sensitive composition containing an alkali-soluble resin (such as novolac resin), a photo-thermal conversion agent (infrared absorbent such as dyes and pigments), and a compound that can cross-link the alkali-soluble resin under heat.

Recently, in view of simplifying the preparation of printing plates, improving the work environment of preparation sites, and environmental considerations, lithographic printing plate precursors that do not require a development process using organic solvents and alkaline materials and that can be loaded in a printer for printing as they are after exposure to light are in high demand. However, the positive photo-sensitive composition described in the Japanese Unexamined Patent Application, First Publication No. H11-202481 contains alkali-soluble resin such as novolac resin as a binder resin. A photo-sensitive lithographic printing plate having such a photo-sensitive layer has to be developed in a strong alkaline developer.

Lithographic printing plate precursors that do not need to be developed after exposure to light are proposed in Japanese Unexamined Patent Application First Publication Nos. H06-43635, H11-65106, and 2000-211097 and Published Japanese translation No. 2002-500973 of PCT International Publication, in which the image forming layer of the lithographic printing plate precursor is irradiated with an infrared laser beam to remove the image forming layer in the irradiated area (ablation), thereby forming an image.

The image forming element described in the Japanese Unexamined Patent Application, First Publication No. H06-43635 consists of an image forming layer comprising a polymer containing an azido group in the side chain on a substrate. The image forming element is exposed to light to decompose the azido group and remove the image forming layer in the exposed area, thereby forming an image. However, because the decomposable azido group is contained in the polymer side chain, the polymer is not easily decomposed and removed by exposure to light, causing the problem of low ablation rate (sensitivity).

The lithographic printing plate precursor described in the Japanese Unexamined Patent Application, First Publication No. H 11-65106 is provided, on an aluminum substrate, with an image forming layer in which a specific polyazo compound is retained by a binder resin. The lithographic printing plate precursor is exposed to light to decompose the polyazo compound and remove the image forming layer in the exposed area, thereby forming an image. However, polyazo compounds are low molecular weight compounds. The image forming layer containing these compounds easily wears, with the problem of poor plate life. Further, polyazo compounds are insoluble in organic solvents. A polyazo compound must be dispersed and applied to a substrate to provide an image forming layer, with the problem of low productivity.

The printing member described in the Japanese Unexamined Patent Application, First Publication No. 2000-211097 is provided with a first imaging layer, a second imaging layer, and a top layer on a substrate. The second imaging layer comprises a polymer containing an azo functional group. With this printing member, the azo group in the exposed area produces a gas during exposure to light. The gas bubbles destroy the imaging layer and cause the top layer to peel off, thereby forming an image. However, this printing member has multiple layers having different compositions on a substrate. Therefore, the layers are likely to peel off at their interfaces, leading to the problem of poor plate life.

The lithographic printing plate described in the Published Japanese translation No. 2002-500973 of PCT International Publication is provided with an ablative-absorptive layer on a supporting substrate. The lithographic printing plate is exposed to light to remove the ablative-absorptive layer in the exposed area, thereby forming an image. However, the ablative-absorptive layer comprises a polymer containing no thermally decomposable groups. Therefore, the polymer is not easily decomposed and removed, with the problem of insufficient sensitivity.

The purpose of the present invention is to provide a lithographic printing plate precursor that can be directly prepared by irradiating it with an infrared laser beam based on digital signals and mounted on a printer for printing in its existent state after exposure to light without developing, the lithographic printing plate precursor having an excellent ablation rate (sensitivity) and the obtained lithographic plate having a good plate life.

### DISCLOSURE OF INVENTION

The lithographic printing plate precursor of the present invention comprises a substrate and a lipophilic layer deposited on the substrate, characterized by the fact that the lipophilic layer comprises a cross-linked product obtained by cross-linking a polymer having a thermally decomposable group on the main chain with a cross-linker. The lithographic printing plate precursor can be directly prepared by irradiating it with an infrared laser beam based on digital signals and mounted on a printer for printing in its existent state after exposure to light without developing. The lithographic printing plate precursor has an excellent ablation rate (sensitivity) and the obtained lithographic printing plate has good plate life.

The ablation rate (sensitivity) is further improved when the thermally decomposable group is one having an azo group.

The obtained lithographic printing plate has further improved plate life when the polymer has a functional group reactive to the cross-linker.

The obtained lithographic printing plate has a more hydrophilic surface in the non-image area when the substrate has a hydrophilic surface.

The ablation rate (sensitivity) is further improved when the lipophilic layer contains a photo-thermal conversion agent.

An excellent lithographic printing plate free from work-up can be obtained when a hydrophilic layer is provided between the substrate and lipophilic layer.

The ablation rate (sensitivity) is further improved when the hydrophilic layer contains a photo-thermal conversion agent.

The preparation method for the printing plate of the present invention is characterized by the fact that the lithographic printing plate precursor of the present invention is exposed to an infrared laser beam to remove the lipophilic layer in the exposed area.

### BRIEF DESCRIPTION OF THE DRAWINGS

FIG. 1 is a schematic cross-section showing an example of the lithographic printing plate precursor of the present invention.

FIG. 2 is a schematic cross-section showing another example of the lithographic printing plate precursor of the present invention.

### BEST MODE FOR CARRYING OUT THE INVENTION

The present invention is described in detail hereafter.

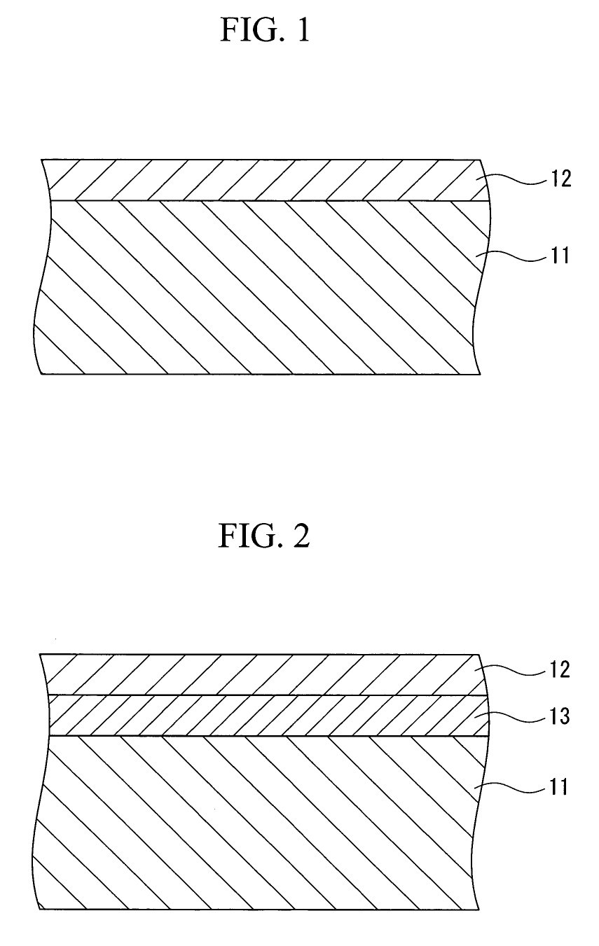

FIG. 1 is a schematic cross-section showing an example of the lithographic printing plate precursor of the present invention. The lithographic printing plate precursor has a substrate 11 and a lipophilic layer 12 deposited on the substrate 11.

<Substrate>

The substrate can be a metal plate such as aluminum, zinc, copper, stainless, and iron; a plastic film such as polyethylene terephtalate, polycarbonate, polyvinyl acetal, and polyethylene; a composite material such as a synthetic resin melt-coated or synthetic resin solution coated paper and a metal layer high-vacuum deposited or laminated plastic film; or a material used as a substrate for other printing plates. Among these, an aluminum substrate and an aluminum-coated composite substrate are particularly preferable.

It is desirable that the substrate be finished to have a hydrophilic surface for improved water retention and adhesion to the photo-sensitive layer. Such surface finishing includes surface roughening, such as blushing, ball polishing, electrolytic etching, chemical etching, liquid honing, sand blasting, and their combination. Among these, surface roughening involving electrolytic etching is particularly preferable.

The electrolytic bath used for electrolytic etching can be a solution of an acid, an alkali, or their salt in water or an aqueous solution of an organic solvent. Among these, an electrolytic solution containing hydrochloric acid, nitric acid, or their salt is particularly preferable.

Surface-roughened aluminum substrate is subject to desmut treatment using an acid or alkali aqueous solution. It is desirable that the obtained aluminum substrate be subject to anodization. Particularly, anodization using a bath containing sulfuric or phosphoric acid is preferable.

Treatment using silicate (sodium silicate, potassium silicate), potassium fluozirconate, phosphomolybdate, alkyl titanate, polyacrylic acid, polyvinyl sulfonic acid, phosphonic acid, phytic acid, or a salt of a hydrophilic organic high-molecular compound and a divalent metal, primer coating of a water-soluble polymer having a sulfonic group for hydrophilicity, coloring using acidic dyes, and silicate electrodeposition can be applied where necessary.

It is also preferable that the aluminum substrate be subjected to sealing following surface roughening (graining) and anodization. The sealing is performed by immersing the aluminum substrate in hot water and a hot aqueous solution containing an inorganic or organic salt, or by using a vapor bath.

<Lipophilic Layer>

The lipophilic layer comprises a cross-linked product obtained by cross-linking a polymer having a thermally decomposable group on the main chain.

(Polymer Having a Thermally Decomposable Group on the Main Chain)

Polymer having a thermally decomposable group on the main chain is not particularly restricted as long as it has a thermally decomposable group on the main chain. Such polymers specifically include polyester and polyurethane having a thermally decomposable group on the main chain. In this instance, “having a thermally decomposable group on the main chain” means that the thermally decomposable group itself is a component of the main chain or the thermally decomposable group directly bonds to, for example, a carbon or nitrogen atom of the main chain.

Polyester having a thermally decomposable group on the main chain can be synthesized by, for example, reacting diol having a thermally decomposable group with dicarboxylic acid, dicarboxylic chloride, or tetracarboxylic acid anhydride and, where necessary, other diols; reacting diol with dicarboxylic acid, dicarboxylic chloride, or tetracarboxylic acid anhydride having a thermally decomposable group and, where necessary, other dicarboxylic acids, dicarboxylic chlorides, or tetracarboxylic acid anhydrides.

Polyurethane having a thermally decomposable group on the main chain can be synthesized by, for example, reacting diol having a thermally decomposable group with di-isocyanate and, where necessary, other diols; reacting diol with di-isoscyanate having a thermally decomposable group and, where necessary, other di-isocyanates.

The molar ratio of a bi-functional compound having a thermally decomposable group (diol, dicarboxylic acid, dicarboxylic chloride, tetracarboxylic acid, and di-isocyanato having a thermally decomposable group) to other bi-functional compounds (diol, dicarboxylic acid, dicarboxylic chloride, tetracarboxylic acid, and di-isocyanato not having a thermally decomposable group) for synthesizing the polyester or polyurethane having a thermally decomposable group on the main chain is preferably 10:90 to 50:50. When the bi-functional compound having a thermally decomposable group is less than 10 molar %, the obtained lithographic printing plate precursor may have an insufficient ablation rate (sensitivity).

The thermally decomposable group includes azo (—N═-), diazo (═N₂), dioxy (—O—O—), disulfide (—S—S—), hydrazide (—NH—NH—), and nitro (—NO₂) groups; oniumu salts such as iodonium (—I⁺—), sulfonium (—S⁺(R)—), and ammonium (—N⁺(R)₂—) groups; and sulfonic ester (—SO₃R), disulfonyl (—SO₂—SO₂—), and thiosulfonic (—S—SO₃—) groups. R in the formulas represents a hydrogen atom or a hydrocarbon group such as alkyl and aryl groups. Among these, azo, ammonium, and nitro groups are preferred thermally decomposable groups because it is easy to directly cut their polymer main chain and the obtained lithographic printing plate precursor has an excellent ablation rate (sensitivity). The azo group is particularly preferable because it produces a gas during thermal decomposition, which accelerates the ablation.

Polymer having a thermally decomposable group on the main chain preferably has a functional group reactive to a cross-linker, described later. Such functional groups include hydroxyl, carboxylic acid, amino, and thiol groups. Having such a functional group, polymers having a thermally decomposable group on the main chain and a cross-linker produce a cross-linked product having a steady cross-linked structure. Therefore, the lipophilic layer has improved wear resistance and the obtained lithographic printing plate has improved plate life.

Polymers having a thermally decomposable group preferably have an average molecular weight of 2,000 to 100,000. When polymer has an average molecular weight of less than 2,000, a weak image is formed and, therefore, the plate life tends to be poor. When polymer has an average molecular weight of greater than 100,000, it is difficult to dissolve in coating solvents, deteriorating coating properties.

Other thermally decomposable compounds can be used in combination with a polymer having a thermally decomposable group on the main chain. Thermally decomposable compounds for combined use include cyanoacrylate polymer, α-methylstyrene polymer, (meta)acrylate monomer polymer; polycarbonate, nitrocellulose, cellulose acetate butyrate, cellulose acetate, polyvinyl chloride, polyvinylidene chloride, polyvinyl pyrrolidone, polyorthoester, acrylonitrile polymer, polyamido, polyurethane, maleic acid resin, nitro compounds such as polythioacetonic ammonium nitrate, potassium nitrate, and sodium nitrate, organic peroxides, azo compounds, diazo compounds, and hydrazine compounds.

(Cross-Linker)

The cross-linker is not particularly restrictive as long as it can cross-link a polymer having a thermally decomposable group on the main chain. The cross-linker includes hexamethoxymethylmelamine, hexahydroxymethylmelamine, dihydromethyl urea, polyvalent ethylene-imine, polyvalent epoxy compounds, polyvalent oxazoline polymer, polyvalent carbodiimido polymer, polyisocyanato, and polyvalent calboxylic acid anhydride. Among these, hexamethoxymethylmelamine is preferable because it leads to a cross-linked product having a high cross-linking density and is stable in a coating solution.

The cross-linker is preferably used in an amount of 10 to 50 parts by weight per 100 parts by weight of the polymer having a thermally decomposable group on the main chain. When the cross-linker is used in an amount of less than 10 parts by weight per 100 parts by weight of the polymer having a thermally decomposable group on the main chain, the lipophilic layer has reduced wear resistance and the obtained lithographic printing plate may have an insufficient plate life. When a cross-linker is used in an amount of more than 50 parts by weight per 100 parts by weight of the polymer having a thermally decomposable group on the main chain, the lipophilic layer is not easily removed when irradiated with an infrared laser, possibly deteriorating the ablation rate (sensitivity).

(Cross-Linked Product)

The cross-linked product is obtained as a result of a polymer having a thermally decomposable group on the main chain being cross-linked by a cross-linker and is the main component of the lipophilic layer.

The cross-linked product is obtained by, for example, applying a coating solution of a polymer having a thermally decomposable group on the main chain and cross-linker in a solvent on a substrate and drying it so that the polymer having a thermally decomposable group on the main chain and cross-linker react with each other under drying heat. The coating solution can additionally contain catalysis for accelerating the reaction between the polymer having a thermally decomposable group on the main chain and the cross-linker.

(Photo-Thermal Conversion Agent)

The lipophilic layer preferably contains a photo-thermal conversion agent that absorbs light and produces heat.

The photo-thermal conversion agent is irradiated with an infrared laser so as to efficiently produce heat and accelerate the ablation of the lipophilic layer. Such agents include a variety of pigments and dyes.

The pigment used in the present invention includes commercially available pigments and those described in color index handbooks “Latest Pigments Handbook, Japanese Society of Pigments Technologies, 1977,” “Latest Pigments Applied Technologies” (CMC Publishing, 1986), and “Printing Ink Technologies” (CMC Publishing, 1984). The pigment may include black, yellow, orange, brown, red, purple, blue, green, and fluorescent pigments and other polymer-coupled coloring agents. Specifically, usable pigments include insoluble azo, azo-lake, condensed azo, chelate azo, phthalocyanine, anthraquinone, perylene and perynone, thioindigo, quinacridone, dioxazine, isoindolynone, quinophthalone, underglaze cobalt blue lake, azine, nitroso, nitro, natural, fluorescent, inorganic, and carbon black pigments.

Among these, carbon black is particularly preferable because it absorbs light in the near-infrared to infrared range and efficiently produces heat and is economically advantageous. Highly dispersive grafted carbon black having a variety of functional groups are commercially available and, for example, described in “Carbon Black Handbook Ver. 3” (Association of Carbon Black, 1995), p. 167 and “Properties and Best Blend and Applications of Carbon Black” (Technical Information Institute Co., Ltd, 1997), p 111. They are all preferably used in the present invention.

Those pigments can be used with or without known surface finishing. Known surface finishing includes resin or wax coating, surfactant deposition, and coupling of a reactive agent such as a silane coupling agent, an epoxy compound, or polyisocyanato to the pigment surface. These surface finishing methods are described in “Nature and Applications of Metal Soap,” (Saiwai-Shobo publishing), “Latest Pigments Applied Technologies” (CMC publishing, 1986), and “Printing Ink Technologies” (CMC publishing, 1984).

The pigment used in the present invention preferably has a particle size of 0.01 to 15 micrometers, more preferably 0.01 to 5 micrometers.

Known conventional dyes can be used in the present invention, including those described in “Dye Handbook” (The Society of Synthetic Organic Chemistry, 1965), “Color Materials Handbook” (Japan Society of Color Materials, Asakura Bookstore, 1989), “Technology and Market of Industrial Dyes” (CMC, 1983), and “Chemistry Handbook Applied Chemistry” (The Chemical Society of Japan, Maruzen Bookstore, 1986). Specifically, azo, metal chain salt azo, pyrazolone azo, anthraquinone, phthalocyanine, carbonium, quininimine, methine, cyanine, indigo, quinoline, nitoro, xanthene, thiazine, azine, and oxazine dyes can be used. Among these, those that absorb near-infrared to infrared light are particularly preferable.

Dyes that absorb near-infrared or infrared light include cyanine, methine, naphthoquinone, squarylium, arylbenzo(thio) pyridinium salt, trimethinethiapyrylium salt, pyrylium compounds, pentamethinethiopyrylium salt, and infrared absorptive dyes.

Among the aforementioned pigments and dyes, a photo-thermal conversion agent that can absorb a specific wavelength light from a light source, described later, and convert it into heat is selected and added to the aforementioned coating solution, thereby being contained in the lipophilic layer. Particularly, the photo-thermal conversion agent having the maximum absorption wavelength (λmax) in the near-infrared to infrared range between 760 and 3000 nm can be preferably used because it allows a photo-sensitive lithographic printing plate obtained to be handled in a bright room.

The photo-thermal conversion agent is preferably used in an amount of 0.5 to 70% by weight, more preferably 1 to 50% by weight, in the lipophilic layer. When it is used in an amount of less than 0.5% by weight, heat is not sufficiently produced, thereby ablation in the exposed area tends to be insufficient. When it is used in an amount of greater than 70% by weight, the lipophilic layer may be easily damaged or the non-image area may be easily subject to work-up.

(Other Components)

The lipophilic layer can contain known additives such as colorants (dyes and pigments), surfactants, plasticizers, and stabilizer.

Preferred dyes include basic oil-soluble dyes such as crystal violet, Malachite green, Victoria blue, methylene blue, ethyl violet, and rhodamine B. Commercially available dyes include “Victoria pure blue BOH” (ex. Hodogaya Chemical Co., Ltd.), “Oil blue #603” (ex. Orient Chemical Industries Co., Ltd.), “VPB-Naps (Victoria pure blue naphthalene sulfonate)” (ex. Hodogaya Chemical Co., Ltd.), and “D11” (ex. PCAS). Pigments include phthalocyanine blue, phthalocyanine green, dioxazine violet, and quinacridone red.

Surfactants include fluorochemical and silicone surfactants.

Plasticizers include diethyl phthalate, dibuthyl phthalate, dioctyl phthalate, tributhyl phosphate, trioctyl phosphate, tricrezyl phosphate, tri(2-chloroethyl) phosphate, and tributhyl citrate.

Known stabilizers for combined use include phosphoric acid, phosphorous acid, oxalic acid, tartaric acid, malic acid, citric acid, dipicolinic acid, polyacrylic acid, benzenesulfonic acid, and toluenesulfonic acid.

Generally, these additives are preferably used in an amount of 0 to 30% by weight in the lipophilic layer depending on their purposes.

<Hydrophilic Layer>

The lithographic printing plate precursor of the present invention can have a hydrophilic layer 13 between the substrate 11 and lipophilic layer 12 as shown in FIG. 2. The hydrophilic layer 13 serves to completely remove the residue of the lipophilic layer 12 that the infrared irradiation has failed to remove in the exposed area using dampening water on printing or printing ink. The lipophilic layer 12 is more easily removed by infrared laser beam irradiation when it is in contact with the hydrophilic layer 13 than when it is in contact with the substrate 11. In addition, the hydrophilic layer 13 serves to prevent the surface of the substrate 11 from being damaged by infrared laser beam irradiation.

Polymer constituting the hydrophilic layer includes polyvinyl alcohols (saponified polyvinyl acetate), carboxylic acid polymer salts, and carboxymethyl cellulose salts. Among these, polyvinyl alcohols is preferably used because it gives an excellent wear resistance.

The hydrophilic layer can contain organic aluminum chelate compounds, organic titanium chelate compounds, or organic zirconium chelate compounds for improved wear resistance. Among these, organic aluminum chelate compounds are preferable because they are significantly stable in the coating solution. The organic aluminum chelate compounds include Orkatics AL-135 ex. Matsumoto Chemical Industries Co., Ltd.

The organic aluminum chelate compound is used in an amount of 20 to 150 parts by weight per 100 parts by weight of the polymer constituting the hydrophilic layer. When the organic aluminum chelate compound is used in an amount of less than 20 parts by weight per 100 parts by weight of the polymer constituting the hydrophilic layer, the cross-linked structure may be incomplete and, therefore, the hydrophilic layer is not expected to have an improved wear resistance. When the organic aluminum chelate compound is used in an amount of more than 150 parts by weight per 100 parts by weight of the polymer constituting the hydrophilic layer, the hydrophilic layer may not be sufficiently hydrophilic.

The hydrophilic layer can contain the aforementioned photo-thermal conversion agent for further improved ablation effect.

The photo-thermal conversion agent is preferably used in an amount of 0.1 to 10% by weight, more preferably 1 to 5% by weight, in the hydrophilic layer. When it is used in an amount of less than 0.1% by weight, an improved ablation rate is not expected. When it is used in an amount of greater than 10% by weight, the hydrophilic layer tends to be less hydrophilic.

<Production of a Lithographic Printing Plate Precursor>

The lithographic printing plate precursor of the present invention is produced by applying to the substrate surface a coating solution that contains at least a polymer having a thermally decomposable group on the main chain and a cross-linker and that is preferably adjusted to have 1 to 50% by weight of nonvolatile components and drying it to form a lipophilic layer on the substrate.

When the lithographic printing plate precursor of the present invention has a hydrophilic layer, it is produced by applying to the substrate surface a coating solution that contains at least a polymer for constituting a hydrophilic layer and that is preferably adjusted to have 1 to 50% by weight of nonvolatile components and drying it to form a hydrophilic layer on the substrate, and then, applying to the hydrophilic layer surface a coating solution that contains at least a polymer having a thermally decomposable group on the main chain and a cross-linker and drying it to form a lipophilic layer on the hydrophilic layer.

Any known conventional solvent can be used as an organic solvent for the coating solution. Among these, those having a boiling point of 40 to 200° C., particularly 60 to 160° C., are selected because of convenience for drying.

The organic solvent includes alcohols such as methyl alcohol, ethyl alcohol, n- or iso-propyl alcohol, n- or iso-butyl alcohol, and diacetone alcohol; ketones such as acetone, methylethylketone, methylpropylketone, methylbutylketone, methylamylketone, methylhexylketone, diethylketone, diisobutylketone, cyclohexanone, methyl cyclohexanone, acetylacetone; hydrocarbons such as hexane, cyclohexane, heptane, octane, nonane, decane, benzene, toluene, xylene, and methoxybenzne; acetic esters such as ethyl acetate, n- or iso-propyl acetate, n- or iso-butyl acetate, ethylbutyl acetate, and hexyl acetate; halides such as methylene dichloride, ethylene dichloride, and monochlorbenzne; ethers such as isopropyl ether, n-butyl ether, dioxane, dimethyl dioxane, and tetrahydrofuran; polyvalent alcohols and their derivatives such as ethylene glycol, methyl cellosolve, methyl cellosolve acetate, ethyl cellosolve, diethyl cellosolve, cellosolve acetate, butyl cellosolve, butyl cellosolve acetate, methoxy methoxy ethanol, diethylene glycol monomethyl ether, diethylene glycol dimethyl ether, diethylene glycol methylethyl ether, diethylene glycol diethyl ether, propylene glycol, propylene glycol monomethyl ether, propylene glycole monomethyl ether acetate, propylene glycol monoethyl ether, propylene glycol monoethyl ether acetate, propylene glycol monobutyl ether, 3-methyl-3-methoxybuthanol, and 1-methoxy-2-propanol; and special solvents such as dimethylsulfoxide, N,N-dimethylformamide, methyl lactate, and ethyl lactate. They can be used individually or in combination.

The coating solution can be applied by, for example, roll coating, dip coating, air knife coating, gravure coating, gravure offset coating, hopper coating, blade coating, wire doctor coating, or spray coating. The coating solution is preferably used in an amount of 10 to 100 ml/m².

The coating solution applied on the substrate or on the hydrophilic layer is generally dried under heated air. The air is preferably heated to 30 to 200° C., particularly to 40 to 140° C. The drying temperature can be fixed or gradually raised throughout the drying.

In some cases, the drying air may be dehumidified for a preferred result. The heated air is preferably fed to the coated surface at a rate of 0.1 to 30 m/sec., particularly 0.5 to 20 m/sec.

The coating solution is generally used in an amount of approximately 0.5 to 5 g/m² by dry weight.

<Preparation Method for a Printing Plate>

The lithographic printing plate precursor of the present invention can be directly prepared by irradiating the lipophilic layer with an infrared laser beam based on digital signals from, for example, a computer.

The preparation method for a printing plate of the present invention is characterized by the fact that the lithographic printing plate precursor of the present invention is exposed to an infrared laser beam to thermally decompose and remove the lipophilic layer in the exposed area.

The present invention uses a high power laser having the peak intensity in the near-infrared to infrared region as an infrared laser source and, specifically, uses a variety of lasers, such as a semiconductor laser and a YAG laser, having the peak intensity in the infrared to infrared range of 760 to 3000 nm.

The lithographic printing plate precursor of the present invention described above has a lipophilic layer comprising a cross-linked product obtained by cross-linking a polymer having a thermally decomposable group on the main chain with a cross-linker. Therefore, the printing plate can be directly prepared by irradiating it with an infrared laser beam based on digital signals and mounted on a printer for printing in its existent state after exposure to light without developing. In other words, the lipophilic layer is exposed to an infrared laser beam to remove the lipophilic layer in the exposed area as a result of laser-induced ablation. Then, the substrate surface or hydrophilic layer is exposed in the exposed area.

The lithographic printing plate precursor of the present invention uses a polymer having a thermally decomposable group on the main chain. When irradiated with an infrared laser beam, the thermally decomposable group is decomposed and the polymer main chain is cut. Therefore, the ablation rate (sensitivity) is significantly improved.

The polymer having a thermally decomposable group on the main chain of the lithographic printing plate precursor of the present invention is cross-linked with a cross-linker. Therefore, the lithographic printing plate obtained after exposure has an excellent plate life.

### EXAMPLES

Examples of the present invention are described hereafter. However, the present invention is not restricted to these examples. Nonvolatile components and mass-average molecular weights were measured as follows.

[Measurement of Nonvolatile Components]

1 g of each sample was dried in a drier at 110° C. for 1 hour. Nonvolatile components were determined based on the weights before and after drying and expressed by % by weight.

[Measurement of Weight-Average Molecular Weight]

The molecular weight was determined by a gel permeation chromatography (GPC) and converted to a polystyrene equivalent molecular weight.

The polymer having a thermally decomposable group on the main chain was synthesized as follows.

[Synthesis of an Azo-Containing Polymer (P-1)]

212.4 g of dried N,N-dimethylacetoamido, 28.8 g (100 mmol) of an azo compound having the formula (a) below [compound name: 2,2′-azobis(2-methyl-N-(2-(1-hydroxybutyl)propionamido))], and 21.8 g (100 mmol) of pyromellitic acid anhydride having the formula (b) below were introduced in a reactor. 20.2 g (200 mmol) of triethylamine as a reaction catalysis was added dropwise to the mixture over 1 hour while the mixture was stirred in the reactor. The temperature of the reaction solution rose to 40° C. and the reaction solution changed in color from colorless to brown. After the dropping, the mixture was further stirred for 10 hours and a solution containing an azo-containing polymer (P-1) was recovered. The solution had 25% by weight of nonvolatile components. The azo-containing polymer (P-1) had a weight-average molecular weight of 4130. 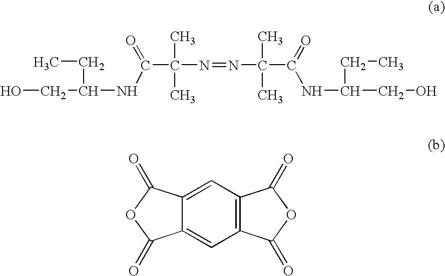
[Synthesis of an Azo-Containing Polymer (P-2)]

138.4 g of dried N,N-dimethylacetoamido, 14.4 g (50 mmol) of an azo compound having the formula (a) above, 25.02 g (100 mmol) of 4,4′-diphenylmethanediisocyanato having the formula (c) below, and 6.71 g (50 mmol) of dimethylol propionic acid having the formula (d) below were introduced in a reactor. 1 g of dibutyltin dilaurate as a reaction catalysis was added to the mixture while the mixture was stirred in the reactor. The temperature of the reaction solution rose to 35° C. and the viscosity of the reaction solution increased. After the addition of the catalysis, the mixture was further stirred for 11 hours and a solution containing an azo-containing polymer (P-2) was recovered. The solution had 25% by weight of nonvolatile components. The infrared absorption spectra obtained showed that the absorption particular to the isocyanato group (2250 to 2275 cm⁻¹) disappeared. The azo-containing polymer (P-2) had a weight-average molecular weight of 7439. 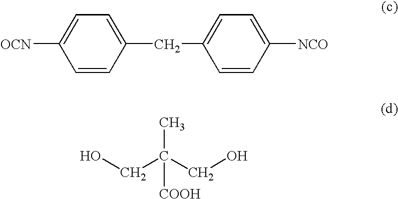
[Synthesis of an Azo-Containing Polymer (P-3)]

243.6 g of dried N,N-dimethylacetoamido, 20.0 g (100 mmol) of an azo compound having the formula (e) below [compound name: 2,2′-azobis(2-methyl-N-(2-hydroxyethylpropionamido))], and 41.0 g (100 mmol) of tetracarboxylic acid anhydride having the formula (f) below (ex. New Japan Chemical, Co., Ltd., TMEG-100) were introduced in a reactor. 20.2 g (200 mmol) of triethylamine as a reaction catalysis was added dropwise to the mixture over 1 hour while the mixture was stirred in the reactor. The temperature of the reaction solution rose to 43° C. and the color of the reaction solution changed from colorless to brown. After the dropping, the mixture was further stirred for 10 hours and a solution containing an azo-containing polymer (P-3) was recovered. The solution had 25% by weight of nonvolatile components. The azo-containing polymer (P-3) had a weight-average molecular weight of 6940. 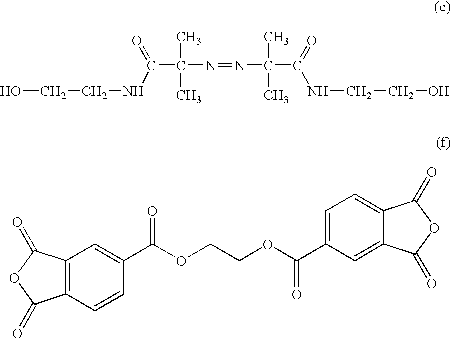
[Synthesis of an Ammonium-Containing Polymer (P-4)]

11.9 g (100 mmol) of bis(2-hydroxyethyl)methylamine and 15.61 g (110 mmol) of methyl iodide were introduced in a reactor and were allowed to react with each other at 90° C. for 2 hours. Then, 300 ml of ethyl acetate was poured into the reactor and the crystal produced under a nitrogen atmosphere was filtered off. An NMR analysis showed that the crystal was an ammonium-containing compound having the formula (g) below. The yield was 20 g.

204.3 g of dried N,N-dimethylacetoamido, 26.1 g (100 mmol) of the ammonium-containing compound having the formula (g) below, and 21.8 g (100 mmol) of pyromellitic acid anhydride were introduced in a reactor. 20.2 (200 mmol) g of triethyamine as a reaction catalysis was added dropwise to the mixture over 1 hour while the mixture was stirred in the reactor. The temperature of the reaction solution rose to 40° C. and the color of the reaction solution changed from colorless to brown. After the dropping, the mixture was further stirred for 10 hours and a solution containing an ammonium-containing polymer (P-4) was recovered. The solution had 25% by weight of nonvolatile components. The ammonium-containing polymer (P-4) had a weight-average molecular weight of 5630. 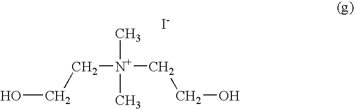
[Synthesis of a Comparative Polymer (P-5)]

166.2 g of dried N,N-dimethylacetoamido, 13.4 g (100 mmol) of dimethylol propionic acid having the formula (d) above, and 21.8 g (100 mmol) of pyromellitic acid anhydride having the formula (b) above were introduced in a reactor. 20.2 (200 mmol) g of triethyamine as a reaction catalysis was added dropwise to the mixture over 1 hour while the mixture was stirred in the reactor. The temperature of the reaction solution rose to 40° C. and the color of the reaction solution changed from colorless to brown. After the dropping, the mixture was further stirred for 10 hours and a solution containing a comparative polymer (P-5) that did not have a thermally decomposable group on the main chain was recovered. The solution had 25% by weight of nonvolatile components. The polymer (P-5) had a weight-average molecular weight of 13045.

[Synthesis of an Azo-Containing Polymer (P-6)]

131.8 g of dried N,N-dimethylacetoamido, 4.4 g (50 mmol) of the azo compound having the formula (a) above, 25.02 g (100 mmol) of 4,4′-diphenylmethanediisocyanato having the formula (c) above, and 4.51 g (50 mmol) of 2-methyl-1,3-propanediol having the formula (h) below were introduced in a reactor. 1 g of dibutyltin dilaurate as a reaction catalysis was added to the mixture while the mixture was stirred in the reactor. The temperature of the reaction solution rose to 35° C. and the viscosity of the reaction solution increased. After the addition of the catalysis, the mixture was further stirred for 11 hours and a solution containing an azo-containing polymer (P-2) was recovered. The solution had 25% by weight of nonvolatile components. The infrared absorption spectra obtained showed that the absorption particular to the isocyanato group (2250 to 2275 cm⁻¹) disappeared. The azo-containing polymer (P-6) had a weight-average molecular weight of 6851. 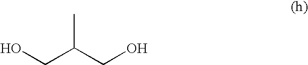
[Aluminum Substrate]

An aluminum plate having a thickness of 0.24 mm was degreased with aqueous sodium hydroxide and, then, electropolished in 20% hydrochloric acid bath to obtain a grained plate having a center line average surface roughness (Ra) of 0.5 μm. This grained plate was anodized in 20% sulfuric acid bath at an electric current density of 2 A/dm² to deposit an oxide coating of 2.7 g/m². Then, the grained plate was rinsed and dried to obtain an aluminum substrate.

### Example 1

7 g of polyvinyl alcohol (ex. Kuraray Co., Ltd., Poval 125) was introduced and dissolved in 140 g of deionized water while stirring and heating at 100° C. for 1 hour. After the solution was cooled down, 10 g of an organic aluminum chelate compound (ex. Matsumoto Chemical Industries Co., Ltd, AL-135) was added and stirred to obtain a coating solution. The coating solution was applied to the aluminum substrate using a #28 bar coater and dried under hot air at 150° C. for 3 minutes to form a hydrophilic layer (H-1) on the aluminum substrate. The hydrophilic layer had a dry coating rate of 2.8 g/m².

30 g of a solution containing the azo-containing polymer (P-1), 30 g of methylcellosolve, 30 g of methylethyl ketone, 2 g of an infrared absorptive dye having the formula (i) below (IR-dye1[2(2-(2-chloro-3-((1,3-dihydro-1,1-dimethyl-3-(4-methyl)-2H-benzo(e)indol-2-ilydene)-1-ethylidene)-cycrohexene-1-yl)-ethenyl)-1,1-dimethyl-3-(4-methyl)-1H-benzo(e)indolium 4-toluene sulfonate]), 2.5 g of hexamethoxymethylmelamine having the formula (j) below as a cross-linker, and 0.1 g of BYK-333 (ex. BYKCHEMICAL) as a surfactant were mixed and stirred to obtain a coating solution. The coating solution was applied to the hydrophilic layer using a #6 bar coater, dried under hot air at 140° C. for 2 minutes to form a lipophilic layer on the hydrophilic layer (H-1), thereby obtaining a lithographic printing plate precursor. The lipophilic layer had a dry coating rate of 1.0 g/m².

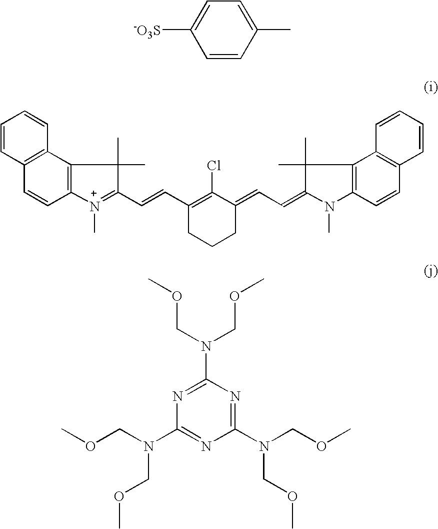

The obtained lithographic printing plate precursor was exposed for imaging in an exposure machine equipped with a near-infrared semiconductor laser (Trendsetter, ex. Creo, 830 nm wavelength, 15 W laser power, 96 rpm revolutions (equivalent to 375 mJ/cm²)). The lipophilic layer in the exposed area was burned away and the hydrophilic layer (H-1) was exposed there. The exposed area was hydrophilic and to be a non-image area on the print. The exposed lithographic printing plate was mounted on a printer and turned several times for idle operation. Then, the lithographic printing plate was dampened with water using a dampening roller before starting the printing. The lipophilic layer in the unexposed area received the ink. After 30,000 printings, print qualities (work-up, plate life) were determined. The results are shown in Table 1.

### Example 2

7 g of polyvinyl alcohol (ex. Kuraray Co., Ltd., Poval 125) was introduced and dissolved in 140 g of de-ionized water while stirring and heating at 100° C. for 1 hour. 10 g of an organic aluminum chelate compound (ex. Matsumoto Chemical Industries Co., Ltd, AL-135) and 0.3 g of a soluble infrared absorptive dye having the formula (k) below (ex. FEWCHEMICAL, 2-(2-(2-chloro-3-((1,3-dihydro-1,1-dimethyl-3-(4-sulfobuthyl)-2H-benzo(e)indol-2-ylidene)-ethylidene)-1-cyclohexen-1-yl)-ethenyl)-1,1-dimethyl-3-(4-sulfobuthyl)-1H-benzo(e)indoliumhydroxyde, inner salt, sodium salt) were added and stirred to obtain a coating solution. The coating solution was applied to the aluminum substrate using a #28 bar coater and dried under hot air at 150° C. for 3 minutes to form a hydrophilic layer (H-2) on the aluminum substrate. The hydrophilic layer had a dry coating rate of 2.8 g/m².

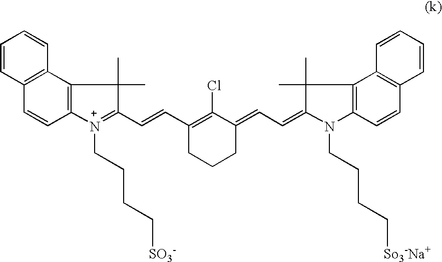

A lipophilic layer was formed on the hydrophilic layer (H-2) to obtaine a lithographic printing plate precursor in the same manner as in Example 1. The lipophilic layer had a dry coating rate of 1.0 g/m².

Then, the obtained lithographic printing plate precursor was exposed for imaging in the same manner as in Example 1. The lipophilic layer in the exposed area was burned away and the hydrophilic layer (H-2) was exposed there. The exposed lithographic printing plate was mounted on a printer and turned several times for idle operation. Then, the lithographic printing plate was dampened with water using a dampening roller before starting the printing. The lipophilic layer in the unexposed area received the ink. After 30,000 printings, print qualities (work-up, plate life) were determined. The results are shown in Table 1.

### Example 3

7 g of polyvinyl alcohol (ex. Kuraray Co., Ltd., Poval 125) was introduced and dissolved in 140 g of deionized water while stirring and heating at 100° C. for 1 hour. 10 g of an organic aluminum chelate compound (ex. Matsumoto Chemical Industries Co., Ltd, AL-135) and 0.3 g of an aqueous carbon emulsion (ex. Cabot, Cabojet 300) were added and stirred to obtain a coating solution. The coating solution was applied to the aluminum substrate using a #28 bar coater and dried under hot air at 150° C. for 3 minutes to form a hydrophilic layer (H-3) on the aluminum substrate. The hydrophilic layer had a dry coating rate of 2.8 g/m².

A lipophilic layer was formed on the hydrophilic layer (H-3) to obtain a lithographic printing plate precursor in the same manner as in Example 1. The lipophilic layer had a dry coating rate of 1.0 g/m².

Then, the obtained lithographic printing plate precursor was exposed for imaging in the same manner as in Example 1. The lipophilic layer in the exposed area was burned away and the hydrophilic layer (H-3) was exposed there. The exposed lithographic printing plate was mounted on a printer and turned several times for idle operation. Then, the lithographic printing plate was dampened with water using a dampening roller before starting the printing. The lipophilic layer in the unexposed area received the ink. After 30,000 printings, print qualities (work-up, plate life) were determined. The results are shown in Table 1.

### Example 4

A lithographic printing plate precursor was obtained in the same manner as in Example 1 except for the lipophilic layer containing the azo-containing polymer (P-2) in place of the azo-containing polymer (P-1). The lipophilic layer had a dry coating rate of 1.0 g/m².

Then, the obtained lithographic printing plate precursor was exposed for imaging in the same manner as in Example 1. The lipophilic layer in the exposed area was burned away and the hydrophilic layer (H-1) was exposed there. The exposed lithographic printing plate was mounted on a printer and turned several times for idle operation. Then, the lithographic printing plate was dampened with water using a dampening roller before starting the printing. The lipophilic layer in the unexposed area received the ink. After 30,000 printings, print qualities (work-up, plate life) were determined. The results are shown in Table 1.

### Example 5

A lithographic printing plate precursor was obtained in the same manner as in Example 1 except for the lipophilic layer containing the azo-containing polymer (P-3) in place of the azo-containing polymer (P-1). The lipophilic layer had a dry coating rate of 1.0 g/m².

Then, the obtained lithographic printing plate precursor was exposed for imaging in the same manner as in Example 1. The lipophilic layer in the exposed area was burned away and the hydrophilic layer (H-1) was exposed there. The exposed lithographic printing plate was mounted on a printer and turned several times for idle operation. Then, the lithographic printing plate was dampened with water using a dampening roller before starting the printing. The lipophilic layer in the unexposed area received the ink. After 30,000 printings, print qualities (work-up, plate life) were determined. The results are shown in Table 1.

### Example 6

A lithographic printing plate precursor was obtained in the same manner as in Example 1 except for the lipophilic layer containing the ammonium-containing polymer (P-4) in place of the azo-containing polymer (P-1). The lipophilic layer had a dry coating rate of 1.0 g/m².

Then, the obtained lithographic printing plate precursor was exposed for imaging in an exposure machine equipped with a near-infrared semiconductor laser (Trendsetter, ex. Creo, 830 nm wavelength, 15 W laser power, and 72 rpm revolutions (equivalent to 500 mJ/cm²)). The lipophilic layer in the exposed area was burned away and the hydrophilic layer (H-1) was exposed there. The exposed lithographic printing plate was mounted on a printer and turned several times for idle operation. Then, the lithographic printing plate was dampened with water using a dampening roller before starting the printing. The lipophilic layer in the unexposed area received the ink. After 30,000 printings, print qualities (work-up, plate life) were determined. The results are shown in Table 1.

### Example 7

A lithographic printing plate precursor was obtained in the same manner as in Example 1 except for the lipophilic layer containing the azo-containing polymer (P-6) in place of the azo-containing polymer (P-1). The lipophilic layer had a dry coating rate of 1.0 g/m².

Then, the obtained lithographic printing plate precursor was exposed for imaging in an exposure machine equipped with a near-infrared semiconductor laser (Trendsetter, ex. Creo, 830 nm wavelength, 15 W laser power, and 180 rpm revolutions (equivalent to 200 mJ/cm²)). The lipophilic layer in the exposed area was burned away and the hydrophilic layer (H-1) was exposed there. The exposed lithographic printing plate was mounted on a printer and turned several times for idle operation. Then, the lithographic printing plate was dampened with water using a dampening roller before starting the printing. The lipophilic layer in the unexposed area received the ink. After 30,000 printings, print qualities (work-up, plate life) were determined. The results are shown in Table 1.

### Comparative Example 1

A lithographic printing plate precursor was obtained in the same manner as in Example 1 except for the lipophilic layer containing the comparative polymer (P-5) in place of the azo-containing polymer (P-1). The lipophilic layer had a dry coating rate of 1.0 g/m².

Then, the obtained lithographic printing plate precursor was exposed for imaging in the same manner as in Example 1. The lipophilic layer in the exposed area remained, not being burned away.

TABLE 1

| | lipophilic | | | | |
|---|---|---|---|---|---|
| | layer | hydrophilic | | plate | print |
| | polymer | layer | sensitivity | life | quality |
| Example 1 | P-1 | H-1 | good | good | good |
| Example 2 | P-1 | H-2 | good | good | good |
| Example 3 | P-1 | H-3 | good | good | good |
| Example 4 | P-2 | H-1 | good | good | good |
| Example 5 | P-3 | H-1 | good | good | good |
| Example 6 | P-4 | H-1 | slow | good | work-up |
| Example 7 | P-6 | H-1 | very fast | poor | good |
| Comparative | P-5 | H-1 | poor | — | — |
| Example 1 | | | exposure | | |

In Table 1, the sensitivity “good” indicates that the lipophilic layer was burned away even with a low power laser. The sensitivity “slow” indicates that a high power laser was required to completely burn the lipophilic layer away.

The lithographic printing plate precursors using a polymer having a thermally decomposable group on the main chain in Examples 1 to 7 had the lipophilic layer in the exposed area removed by means of the exposure and used as they were without developing them.

The lithographic printing plate precursors using a polymer having an azo group that produces a gas during thermal decomposition in Examples 1 to 5 and 7 had good sensitivities (ablation rates).

The lithographic printing plate precursors using a polymer having a functional group that is cross-linked with a cross-linker in Examples 1 to 6 had good plate lifes.

### INDUSTRIAL APPLICABILITY

The lithographic printing plate precursor of the present invention can be directly prepared by irradiating it with an infrared laser beam based on digital signals and mounted on a printer for printing in its existent state after exposure to light without developing, the lithographic printing plate precursor having an excellent ablation rate (sensitivity) and the obtained lithographic printing plate having an excellent plate life. This lithographic printing plate precursor serves to simplify the preparation of printing plates, improve the work environment of preparation sites, and contribute to being environmentally friendly.

1. A lithographic printing plate precursor, comprising on a substrate, an oleophilic layer containing a cross-linked product, that is cross-linked by a polymer having a heat decomposable group in the main chain and a cross-linking agent.

2. The printing plate precursor of claim 1, wherein said heat decomposable group is an azo group.

3. The lithographic printing plate precursor of claim 1, wherein said polymer has a functional group that is capable of reacting with a cross-linking agent.

4. The lithographic printing plate precursor of claim 1, wherein said substrate has a hydrophilic surface.

5. The lithographic printing plate precursor of claim 1, wherein said oleophilic layer further contains a photo-to-heat converting material.

6. The lithographic printing plate precursor of claim 1, further comprising a hydrophilic layer between said substrate and said oleophilic layer.

7. The lithographic printing plate precursor of claim 6, wherein said hydrophilic layer contains a photo-to-heat converting material.

8. A method for preparing a lithographic printing plate comprising:
exposing the lithographic printing plate precursor of claim 1, to IR radiation and removing the exposed part of said oleophilic layer.
